(19) United States
(12) Patent Application Publication
(10) Pub. No.: US 2017/0031915 A1
(43) Pub. Date: Feb. 2, 2017

(54) PROFILE VALUE SCORE

(71) Applicant: LinkedIn Corporation, Mountain View, CA (US)

(72) Inventors: Drew Scott Baird Moxon, Mountain View, CA (US); Xin Fu, Sunnyvale, CA (US)

(21) Appl. No.: 14/815,835

(22) Filed: Jul. 31, 2015

(51) Int. Cl. G06F 17/30; H04L 29/08

(52) U.S. Cl. CPC G06F 17/3053; H04L 67/306

(57) ABSTRACT

A system and method for generating a profile value score to prioritize members for opportunities. The system receives a member opportunity request. In response, the system generates a list of members in response to the received member opportunity request, wherein the list of members is determined based on member profile data stored at a social networking system. For each member in the generated list of members, the system generates a profile value score based on the stored member profile data. The system ranks the members of the generated list at least in part based on the generated profile value scores. The system then selects one or more members in the list of members based on the ranking of members in the generated list.

### TECHNICAL FIELD

The disclosed example embodiments relate generally to the field of data analysis and, in particular, to specialized computing devices that provide increased social networking service engagement.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking. Large social networks allow members to connect with each other and share information. As the number of members grows, social networks need to prioritize which information to share with each member. These determinations can be made based on the characteristics of the receiving member, the information itself, or the characteristics of the sharing member.

Social networks enable members to interact and share information with other members. In some examples, social networking services automatically provide recommendations for a first person to share contact with, or otherwise interact with a second person. These recommendations may be the result of automated algorithms. In other examples, the social networking service may provide special offers to one or more members as a result of being selected by an algorithm.

### DESCRIPTION OF THE DRAWINGS

Some example embodiments are illustrated by way of example and not limitation in the figures of the accompanying drawings, in which:

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 depicts a block diagram of an exemplary data structure for the member profile data for storing member profiles, in accordance with some embodiments.

FIG. 5 is a member interface diagram illustrating an example of a member interface or web page having a personalized data feed (or content stream) via which a member of a social network service receives messages, status updates, notifications, and recommendations, according to some embodiments.

FIG. 6 is a block diagram demonstrating the modules employed to generate a composite profile value score, in accordance with some example embodiments.

FIGS. 7A-7C are a flow diagram illustrating a method, in accordance with some example embodiments, for generating a composite profile value score.

FIG. 8 is a block diagram illustrating an architecture of software, which may be installed on any one or more of devices, in accordance with some example embodiments.

FIG. 9 is a block diagram illustrating components of a machine, according to some example embodiments.

Like reference numerals refer to corresponding parts throughout the drawings.

### DETAILED DESCRIPTION

The present disclosure describes methods, systems, and computer program products for generating profile value scores for member profiles. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

Social networks enable members to interact and share information with other members. As such, there are a large number of opportunities available for members to be recommended as contacts for other members, for content items created by a member to be shared with other members, for members to receive offers, and so on. Indeed, there are often so many opportunities that the social networking service determines which of the potential opportunities are allocated to which members (or which content items created by a member).

For example, Member A loads a web page associated with the social networking system, and the web page includes an area that is filled with contact recommendations for Member A. The social networking system determines which other members should displayed (and thus have the opportunity to grow the number of members to which the member is connected). In some example embodiments, the social networking system will use a profile value score for the potential recommended members to determine which one or more members to recommend.

The social networking system stores member profiles for each member of the social networking system. Each member profile includes biographic and demographic information about the member. The member profiles also include interaction data for the member including member pages viewed, offers accepted, likes, comments, and so on. In some example embodiments, the social networking system uses the member profile data to select a group of members that are eligible to fill an opportunity. For example, the social networking system determines that an article about privacy issues in computing would of interest to a member, and selects a plurality of recent articles created by or linked to by members of the social networking service.

For each member (e.g., the creator of a content item, a potential connection, and so on), the social networking system generates a profile value score. In some example embodiments, the profile value score is a score that represents the degree to which the member has received opportunities. In some example embodiments, the profile value score is created from one or more component sub-scores. For example, a profile value score is a composite of a topical expert score, a job seeker score, a network building score, and a network engagement score. Each component sub-score represents a particular aspect of member interactions through the social networking system.

When creating a composite profile value score from a plurality of component sub-scores, the social networking system assigns a specific weight to each sub-score. In some example embodiments, the weight of each sub-score is based on a determination of which components are most important to the particular member. For example, a member who is currently searching for a new job will have the job seeker sub-score prioritized.

Once the composite profile value score for each of the list of potential members is determined, the social networking system ranks each member based on their associated profile value score. In some example embodiments, members are ranked such that members with a lower profile value score (e.g., members that have thus far received fewer opportunities) are ranked higher, with all other things being equal.

In some example embodiments, the social networking system then selects one or more members (or content items created by members) to receive the determined opportunity. For example, the top three ranked members will be displayed in a recommended contact section of a web page.

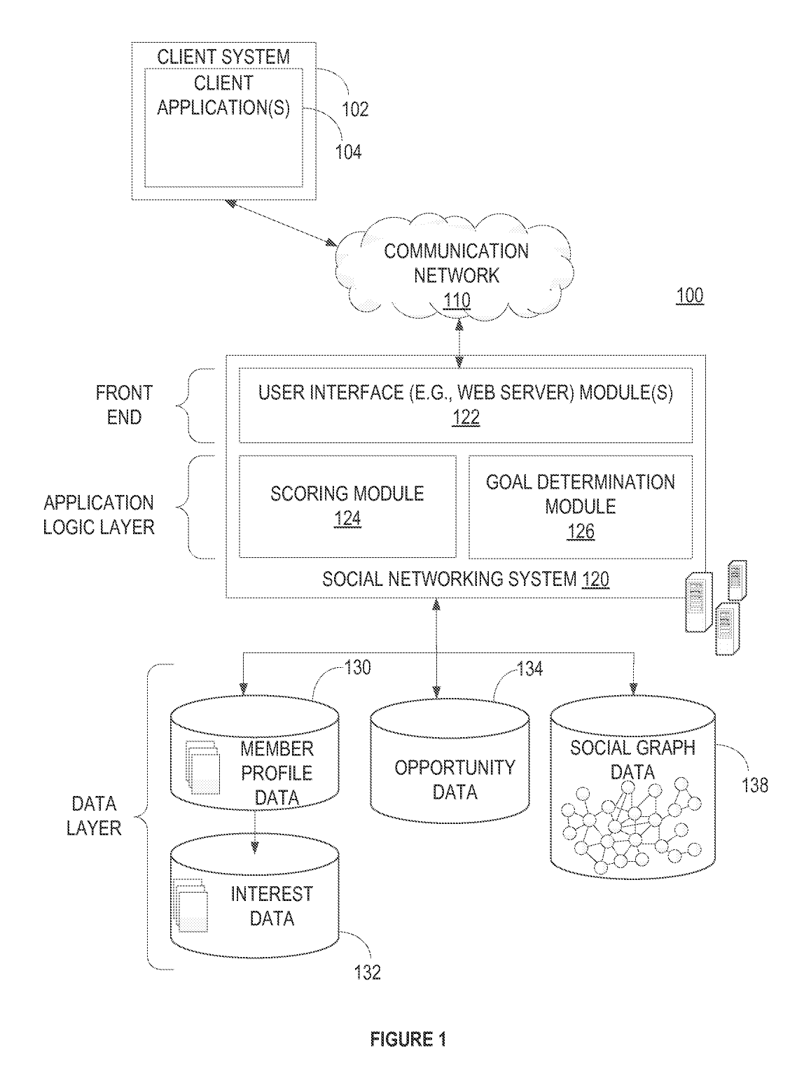

FIG. 1 is a network diagram depicting a client-social networking system environment 100 that includes various functional components of a social networking system 120, in accordance with some example embodiments. The client-social networking system environment 100 includes one or more client systems 102 and a social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to communicate with the social networking system 120 and displays information received from the social networking system 120.

In some example embodiments, the client system 102 includes an application specifically customized for communication with the social networking system 120 (e.g., a Linkedin iPhone application). In some example embodiments, the social networking system 120 is a server system that is associated with a social networking service. However, the social networking system 120 and the server system that actually provides the social networking service may be completely distinct computer systems.

In some example embodiments, the client system 102 sends a request to the social networking system 120 for a webpage associated with the social networking system 120. For example, a member uses a client system 102 to log into the social networking system 120 and clicks a link to send a request to the social networking system 120 for information about a content item on a social networking webpage. In response, the client system 102 receives the requested data (e.g., a blog post and associated comments) and displays them on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various example embodiments are by no means limited to this architecture.

As shown in FIG. 1, the front end consists of a user interface module (e.g., a web server) 122, which receives requests from various client systems 102 and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser 106 applications or applications that have been developed for a specific platform to include any of a wide variety of mobile devices and operating systems.

As shown in FIG. 1, the data layer includes several databases, including databases for storing data for various members of the social networking system 120, including member profile data 130, interest data 132 (e.g., data describing the interests of one or more members of the social networking system 120), opportunity data 134 (e.g., data describing opportunities each member has already received and/or currently available opportunities), and social graph data 138, which is data stored in a particular type of database that uses graph structures with nodes, edges, and properties to represent and store data. Of course, with various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes interest data 132. In other example embodiments, the interest data 132 is distinct from, but associated with, the member profile data 130. The interest data 132 stores data detailing one or more interests for members of the social networking system 120 including topics of interest to the member, hobbies, sports teams, companies, technology products, non-government organizations, search history, likes, follows, content rating, and so on. In some example embodiments, this information is only tracked with member permission.

The opportunity data 134 stores data that either describes previous opportunities that members have had (e.g., when content created by a first member is shared with other members or the first member is recommended to another member) or that describes currently available opportunities.

Once registered, a member may invite other members, or be invited by other members, to connect via the network service. A “connection” may include a bi-lateral agreement by the members, such that both members acknowledge the establishment of the connection. Similarly, with some example embodiments, a member may elect to “follow” another member. In contrast to establishing a “connection,” the concept of “following” another member typically is a unilateral operation and, at least with some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some example embodiments, the social networking service may include a photo sharing application that allows members to upload and share photos with other members. As such, at least with some example embodiments, a photograph may be a property or entity included within a social graph. With some example embodiments, members of a social networking service may be able to self-organize into groups, or interest groups, organized around a subject matter or topic of interest. In some example embodiments, the data for a group may be stored in a database. When a member joins a group, his or her membership in the group will be reflected in the organization interaction data, the member interaction data, and the social graph data 138.

In some example embodiments, the application logic layer includes various application server modules, which, in conjunction with the user interface module(s) 122, generate various user interfaces (e.g., web pages) with data retrieved from various data sources in the data layer. With some example embodiments, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a scoring module 124 or a goal determination module 126 may be separately implemented in their own application server modules.

In addition to the various application server modules, the application logic layer includes a scoring module 124 and/or a goal determination module 126. As illustrated in FIG. 1, with some example embodiments, the scoring module 124 or the goal determination module 126 are implemented as services that operate in conjunction with various application server modules. For instance, any number of individual application server modules can invoke the functionality of the scoring module 124 or the goal determination module 126. However, with various alternative example embodiments, the scoring module 124 or the goal determination module 126 may be implemented as their own application server modules such that they operate as stand-alone applications. With some example embodiments, the scoring module 124 or the goal determination module 126 include or have an associated publicly available API that enables third-party applications to invoke the functionality they provide.

Generally, the scoring module 124 conducts an analysis of various data stored in the member profile data 130, the interest data 132, and the social graph data 138 to determine a profile value score for one or more members. In some example embodiments, the profile value score represents the amount of opportunity that the member has been exposed to.

In some example embodiments, the scoring module 124 generates a profile value score by first generating a plurality of sub-scores associated with different aspects of a profile opportunity. All of the sub-scores are then combined to form a composite profile value score.

In some example embodiments, possible sub-scores include, but are not limited to, a topical expert score, a job seeker score, a network building score, and a network engagement score. Each sub-score measures different criteria and represents different types of opportunities.

In some example embodiments, a topical expert score represents the degree to which a member has established themselves as an expert (e.g., for a particular topic, category, or group) in the social networking system. In some example embodiments, this is measured for a first member based on the number of unique members that engage with the profile page or content produced by the first member but are not connected to the first member through the social graph. A member is determined as not connected to the first member when there are at least a predetermined number of connections between them (e.g., at least a five degree connection or more).

In some example embodiments, the topical expert score is measured by determining the number of messages (e.g., e-mails, in-system messages, text messages, and so on) received by a first member over a given time period (e.g., a month) from members not connected to the first member. The scoring module 124 also determines the number of profile views that the first member has received from other members. For example, the score could be generated by the following general formula (w1)*number of messages+(w2)*number of profile views=topical expert score, wherein w1 and w2 are weights.

In some example embodiments, the scoring module 124 only considers non-anonymous views (e.g., when members can determine whether their visits of profile pages are anonymous or not). In some example embodiments, the scoring module 124 only considers messages that are relevant to the topic for which the first member is an expert (e.g., based on the content of the message or the identity of the message sender). Similarly, profile views are weighted depending on the degree to which the viewing member is associated with the topic of expertise (e.g., based on the viewing members occupation, education, activity, and so on).

In some example embodiments, the scoring module 124 generates a job seeker score based on the opportunities that the member has had that might lead towards a job. For example, the scoring module 124 measures the number of messages received from a recruiter or job poster. The scoring module 124 determines whether a member is a job poster or a recruiter based on the member's biographical information and past interactions. For example, if a member lists their occupation as legal recruiter, has posted jobs to the social networking system (e.g., system 120 in FIG. 1) in the past, or uses the social networking system's recruiting tools, the system will determine that the member is a job poster or recruiter.

The scoring module 124 can also determine the number of profile views from members who are determined to be recruiters and/or job posters. In some example embodiments, the scoring module 124 weights each view or message based on the degree to which the recruiter/job poster is related to the type of job that the member is likely to seek (e.g., a score for a lawyer will more heavily weight messages from recruiters who deal in the legal world).

In some example embodiments, the scoring module 124 generates a network building score based on the number of new connections that a member has established within a predetermined period of time (e.g., four weeks or any amount of time that is appropriate). The scoring module 124 will include both connection requests that are sent from the first member and accepted by another member and connection requests that are sent from another member and accepted by the first member. In some example embodiments, the scoring module 124 also includes the number of times that the first member has been recommended to another member as a potential contact.

In some example embodiments, the scoring module 124 generates a network engagement score based on the amount and type of interaction that a member has with the other members of their social network. For example, messages, likes, comments, and other engagement with the profiles and content of connected members (and reciprocal contact from the connected members) are analyzed by the scoring module 124 to create this sub-score.

In some example embodiments, the goal determination module 126 determines one or more goals of a member. Using the determined goal information, the goal determination module 126 generates weights for the different sub-scores that make up the composite profile value score. For example, if the goal determination module 126 determines that member A has a goal of getting a new job, the job seeker sub-score will be more heavily weighted than the other sub-scores. Similarly, if a member has recently moved to a new location, the goal determination module 126 determines that the member will likely be looking to make new contacts and will increase the weight given to the network building score.

In some example embodiments, the goal determination module 126 receives explicit information from a member (e.g., when a member signs up with the social networking system 120) about the current goals of the member. In other example embodiments, the goal determination module 126 analyzes a member's interactions, interactions, and data to determine what a current goal of a member might be.

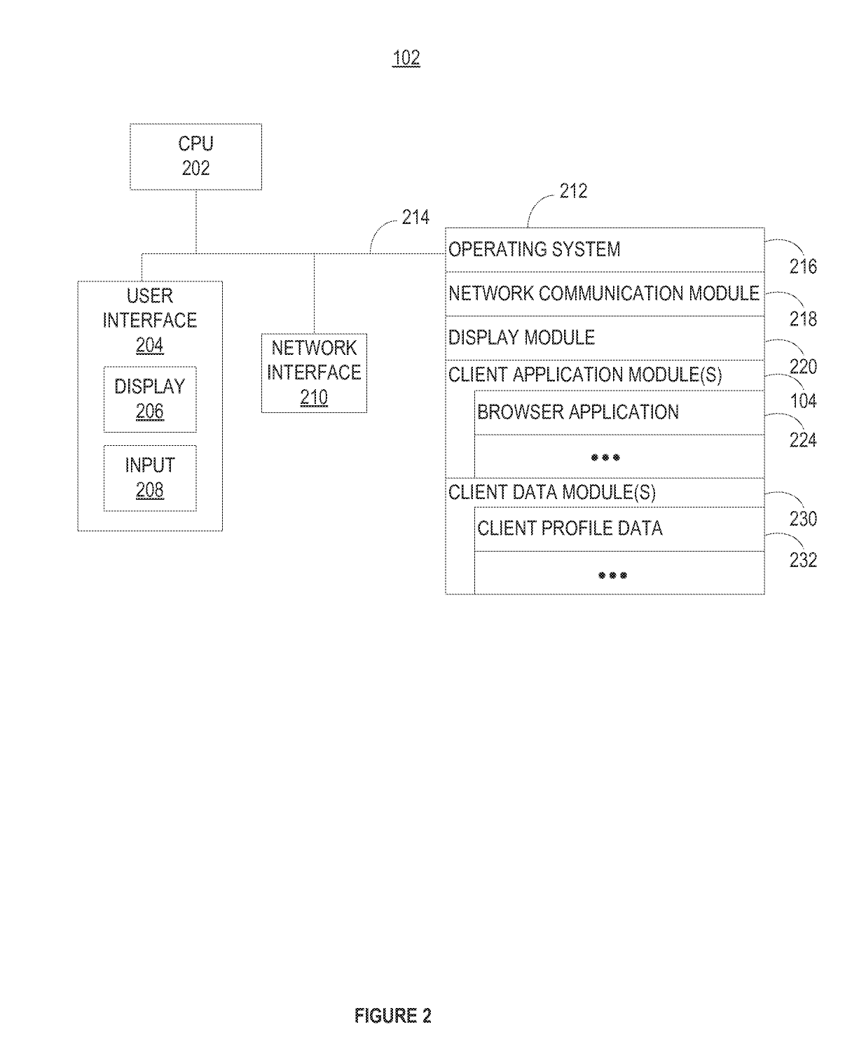

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer-readable storage medium.

In some example embodiments, memory 212, or the computer-readable storage medium of memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications 104 for handling various aspects of interacting with the social networking system 120 (FIG. 1), including but not limited to:
   a browser application 224 for requesting information from the social networking system 120 (e.g., product pages and member information) and receiving responses from the social networking system 120; and
client data module(s) 230 for storing data relevant to the clients, including but not limited to:
   client profile data 232 for storing profile data related to a member of the social networking system 120 associated with the client system 102.

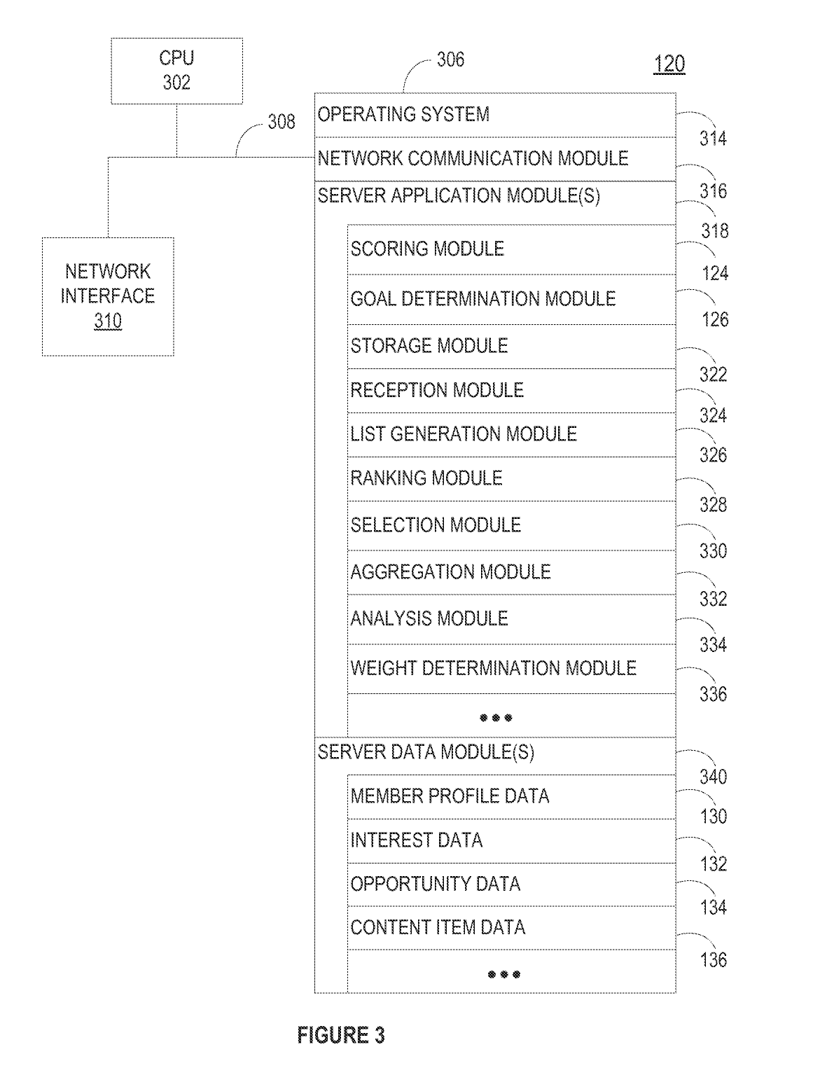

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer-readable storage medium. In some example embodiments, memory 306, or the computer-readable storage medium of memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more communication network interfaces 310 (wired or wireless) and one or more communication network 110, such as the Internet, other WANs, LANs, MANs, and so on;
one or more server application modules 318 for performing the services offered by the social networking system 120, including but not limited to:
   a scoring module 124 for generating a profile value score for each member as needed, wherein the profile value score includes a plurality of sub-scores and represents the level of opportunity that a member has had within a predetermined period of time;
   a goal determination module 126 for determining what goals a member has with respect to the social networking system 120 and, once the one or more goals are determined, adjusting the weight given to each sub-score in the profile value score such that the sub-scores associated with the member's determined goals are weighted more heavily than sub-scores not related to a current goal of the member,
   a storage module 322 for storing member profile data 130 and interaction data associated with members of the social networking system 120 when that data is received;
   a reception module 324 for receiving a notification of a member opportunity (e.g., the system determines that member recommendations are needed or that a members interaction page needs content to be displayed);
   a list generation module 326 for generating a list of members that meet the base qualifications for a given opportunity (e.g., the right topic for content items, members who live in the correct area or have connections in common, and so on);
   a ranking module 328 for ranking a generated list of members based on a profile value score associated with each member in the list;
   a selection module 330 for selecting one or more of a ranked list of members based on the their respective rankings and the number of available opportunity spots;
   an aggregation module 332 for aggregating a plurality of sub-scores into a single composite profile value score, wherein each sub-score has a relative weight and the relative weight of each sub-score determines the effect that the sub-score has on the final composite scores;
   an analysis module 334 for analyzing the actions of members through the social networking system and determining, based on those actions, the priorities or goals that are important to each member; and
   a weight determination module 336 for determining the weight to assign to each sub-score in an aggregate score based on the determined goals of a member; and
server data module(s) 340, holding data related to social networking system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member's activity, social graph data, overall trend data for the social networking system 120, and so on;
   interest data 132 including data representing a member's stated or inferred interest in one or more topics;
   opportunity data 134 including data describing when and how each particular member has received opportunities to share information, make connections, and so on, and data describing current possible opportunities and including data describing what members or content items would be appropriate for filling those opportunities; and
   content item data 136 including data for each content item (e.g., post, link, comment, video, and so on) available through the social networking system 120, wherein the data includes information on the member who created or linked to the content item.

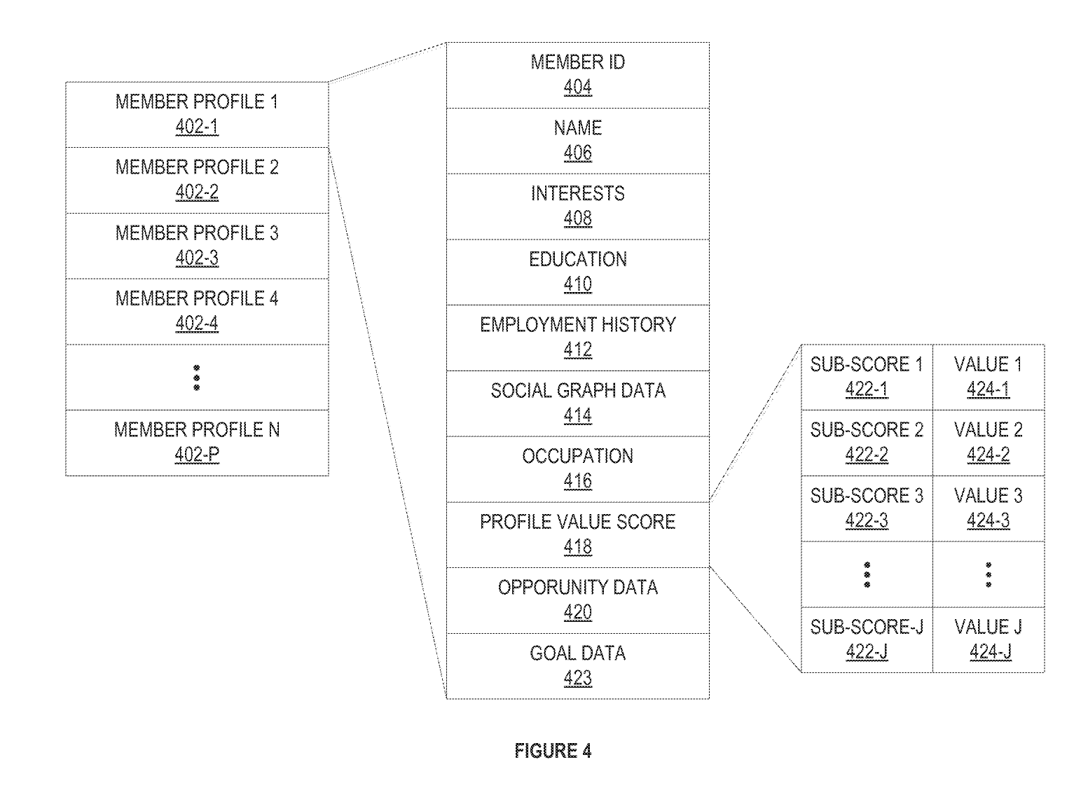

FIG. 4 depicts a block diagram of an exemplary data structure for the member profile data 130 for storing member profiles, in accordance with some embodiments. In accordance with some embodiments, the member profile data 130 includes a plurality of member profiles 402-1 to 402-P, each of which corresponds to a member of the social networking system (e.g., system 120 in FIG. 1).

In some embodiments, a respective member profile 402 stores a unique member identifier (ID) 404 for the member profile 402, a name 406 for the member (e.g., the member's legal name), member interests 408, member education history 410 (e.g., the high school and universities the member attended and the subjects studied), employment history 412 (e.g., member's past and present work history with job titles), social graph data 414 (e.g., a listing of the member's relationships as tracked by the social networking system (e.g., system 120 in FIG. 1)), occupation 416, profile value score 418, opportunity 420 (e.g., data describing when the member has been suggested as potential contacts or when media content items produced by the member have been posted/shared with other members)), and goal data 423.

In some embodiments, the profile value score 418 is a composite score that is created by combining several sub-scores (422-1 to 422-J) and associated sub-score values (424-1 to 424-J). Each sub-score 422 represents a particular aspect of the profile value score 418 that can be considered separately. For example, while the profile value score 418 represents the amount of opportunity a member has had generally, it does not distinguish between different types of interactions or experiences. For example, the amount of opportunity a member has in job seeking is likely distinct from the amount of opportunity a member has to interact with members in their social graph. Therefore a sub-score is generated for each aspect and then the various sub-scores are combined into a composite profile value score. In some example embodiments, each sub-score is given a specific weight when creating the composite profile value score 418. In some example embodiments, one or more sub-scores can have their weights set to zero such that those aspects are not included in the profile value score 418.

For example, a composite score with four component sub-scores could be generated by the formula (sub-score A*Weight A)+(sub-score B*Weight B)*(sub-score C*Weight C)*(sub-score D*Weight D).

In some example embodiments, the opportunity data 420 is data that describes any opportunities that the member has received. For example, when the member is recommended as a potential contact, the social networking system (e.g., system 120 in FIG. 1) records that as an opportunity given to the member. Similarly, if a content item created by the member is posted on the interaction feed of another member, the social networking system (e.g., system 120 in FIG. 1) will also record that opportunity.

In some example embodiments, the goal data 423 records data concerning the current goal of the member at the current time. For example, the member will select a particular goal from a list of potential goals. The social networking system (e.g., system 120 in FIG. 1) then adjusts the weights of the various sub-scores based on the determined goal. In some example embodiments, the goal is inferred based on record activity. If the member has recently reported a new job, the social networking system (e.g., system 120 in FIG. 1) will infer that the member has job-seeking as a much reduced priority and that building new contacts is an increased priority. Thus, the weight associated with the job seeking sub-score is decreased and the weight associated with the growing social network sub-score is increased.

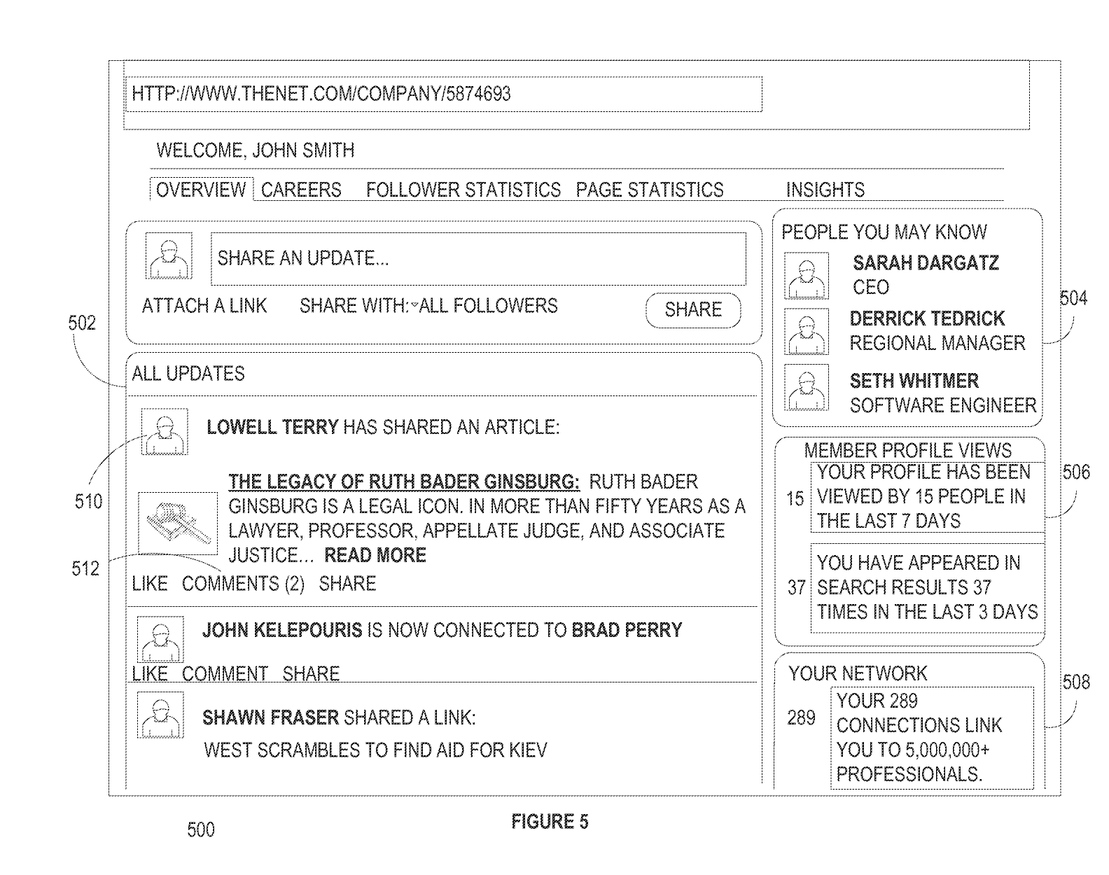

FIG. 5 is a member interface diagram illustrating an example of a member interface 500 or web page having a personalized data feed (or content stream) via which a member of a social network service receives messages, status updates, notifications, and recommendations, according to some embodiments. In the example member interface of FIG. 5, the content module depicted represents a personalized data feed or content stream for a member of the social network service with the name John Smith.

In this example, not only does the content stream present content selected specifically for John Smith, the content stream itself is presented within a member interface or web page that is personalized for John Smith. With some embodiments, a personalized data feed or content stream has associated with it various configuration settings that enable the member to specifically filter or select the type of content the member desires to view in the personalized content stream.

In this example, a personal data feed 502 is displayed. The personal data feed 502 includes a plurality of message or status updates. Each update notifies the member about a specific action that has taken place in the social networking system (e.g., system 120 in FIG. 1). For example, the update with reference number 510 is an article shared by a social contact of the member.

The content update 510 also includes buttons or links 512 that enable the viewing member to interact or engage with the recommendation. In particular, a button labelled “like” allows the member to upvote the suggestion or express a favorable opinion of the recommendation and the course it recommends. Similarly, a button labelled “share” allows the viewing member to share the recommendation or status update with another member of the social network service (for example, by re-publishing the recommendation to another member's personal data feed or content stream).

Finally, a button labelled “comment” allows the member to comment on the recommendation or status update (for example, by entering some text that will be presented with the recommendation or status update and be visible in the personalized content streams of other members of the social network service). Clicking on the comment button will also display any currently hidden comments. In this case the comment button includes the number 2, indicating that two comments are currently hidden.

The user interface 500 also includes information in side sections of the interface including a contact recommendation section 504, profile viewership statistic section 506, and a social graph statistic section 508.

In this example, there are two or more areas where opportunities are offered to members of the social networking system (e.g., system 120 in FIG. 1). For example, the social networking system (e.g., system 120 in FIG. 1) determines which members to display in the contact recommendation section 504. In some example embodiments, the members are selected, at least in part, on the degree to which those members have recently had opportunities to make new connections.

Similarly, the interaction feed 502 includes a content item that includes an article written by a member 510. This also represents an opportunity for the author or creator of the content item. In some example embodiments, content items included in interaction feed are selected, at least in part, based on the profile value score of the members.

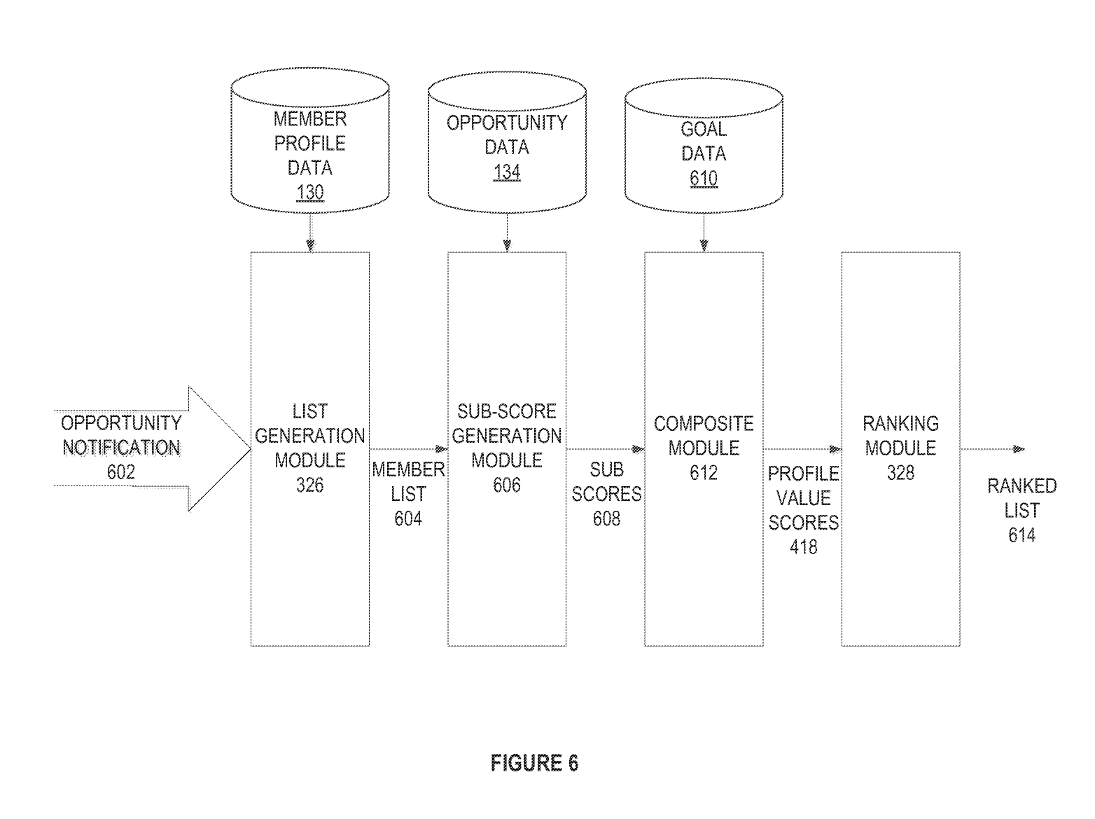

FIG. 6 is a block diagram demonstrating the modules used to generate a composite profile value score, in accordance with some example embodiments.

In some example embodiments, the social networking system (e.g., system 120 in FIG. 1) receives an opportunity notification 602. In some example embodiments, an opportunity is identified whenever the social networking system (e.g., system 120 in FIG. 1) determines it needs to recommend a member or content to another member. For example, some web pages in the social networking system (e.g., system 120 in FIG. 1) include a list of suggested member contacts. Each potential recommendation slot is an opportunity.

Similarly, the social networking system (e.g., system 120 in FIG. 1) creates interaction lists for each member when those members navigate to a webpage that includes said interaction lists (e.g., the member accesses their social networking system (e.g., system 120 in FIG. 1) homepage). The social networking system 120 determines which content is displayed in the interaction list (e.g., based on the members preferences, past behavior, relationships, and so on). In some example embodiments, a member is determined to have been given a content exposure opportunity each time a content item created by that member is displayed on a members interaction feed.

In some example embodiments, the opportunity notification 602 includes information describing the context of the opportunity (e.g., the type of opportunity, the target member to whom the opportunity is to be displayed, the interests of the target member, the social graph of the target member, and so on).

The list generation module 326 receives the opportunity notification 602. In response, the list generation module 326 uses the information included with the opportunity notification 602 (e.g., information about the opportunity) to generate a list of potential members who meet the basic requirements of the opportunity. For example, the list generation module 326 receives a notification that three members are needed for contact recommendation to a first member. The list generation module 326 then identifies a list of members to consider for the recommendation of the three members based on the first and second degree social contacts for the first member and the interactions of the first member.

In some example embodiments, the list generation module 326 accesses data in the member profile data 130 to ensure that the member list 604 is based on a member's interests, demographic data, and social contacts.

The list generation module 326 then transmits the member list 604 to a sub-score generation module 606. The sub-score generation module 606 generates one or more sub-scores for each member in the member list 604. Each sub-score represents a different aspect of a profile value. For example, a sub-score can represent the degree to which a member is considered an expert in a particular field, the amount of opportunities the member has had to find a job, the amount that the member has been able to grow their personal contact network, and so on.

The sub-score generation module 606 uses data stored in the opportunity data 134 to generate the sub-scores 608 for each member included in the member list 604. The sub-score generation module 606 sends the generated sub-scores 608 to a composite module 612.

The composite module 612 uses the one or more sub-scores for each member to generate a composite profile value score 418 for each member in the member list 604. In some example embodiments, the composite module 612 uses goal data 610 (e.g., data describing which sub-scores are most important to each member at a given time) to determine a weight for each sub-score such that sub-scores that have higher weight influence the composite score more than sub-scores that have lower weight.

In some example embodiments, the composite module 612 sends the profile value scores 418 for each member in the member list 604 to the ranking module 328. In some example embodiments, the ranking module 328 uses the profile values scores to order the members in the member list 604. In some example embodiments, members with low profile value scores (e.g., members that have few opportunities in the past) are ranked higher than members with high profile value scores (e.g., members that have had more opportunities in the past).

In some example embodiments, the ranking module orders the members, based at least in part on the profile value scores 418 received from the composite module 612. The resulting ranked list 614 of members is then used to select one or more members to receive the opportunity (e.g., be recommended to another member or have their content shared more widely.).

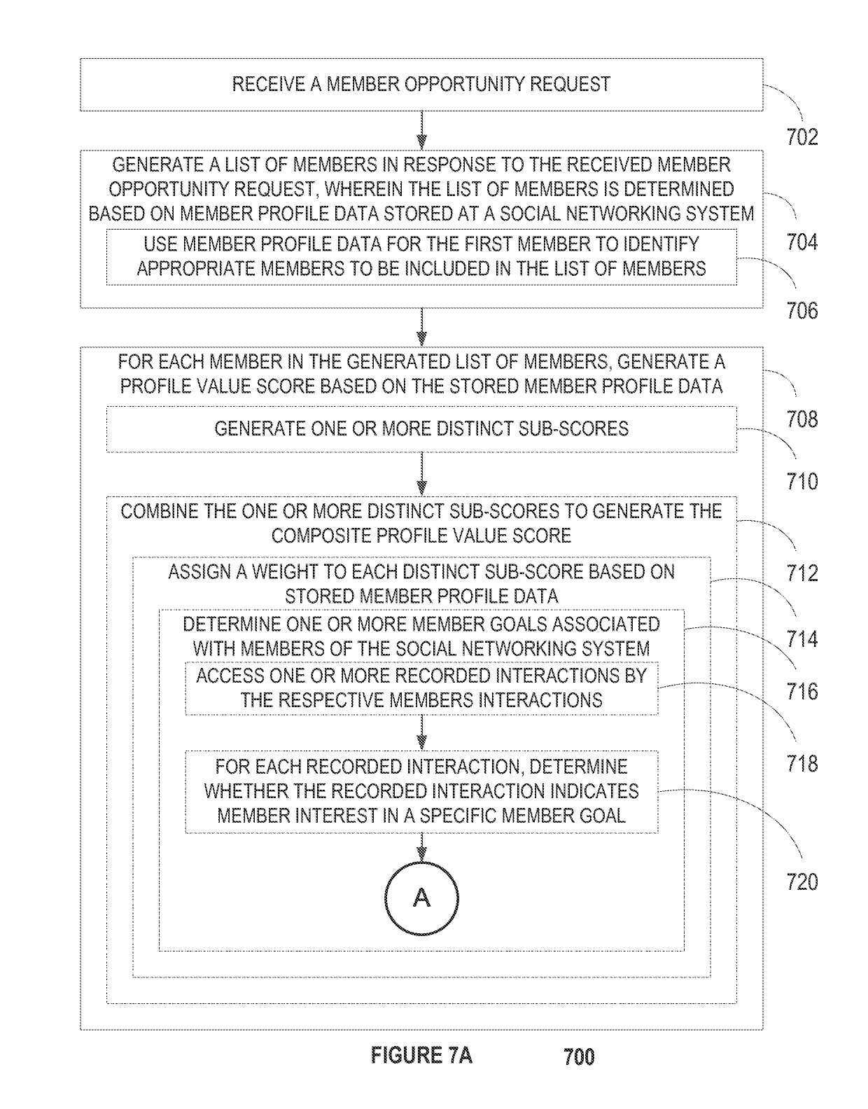

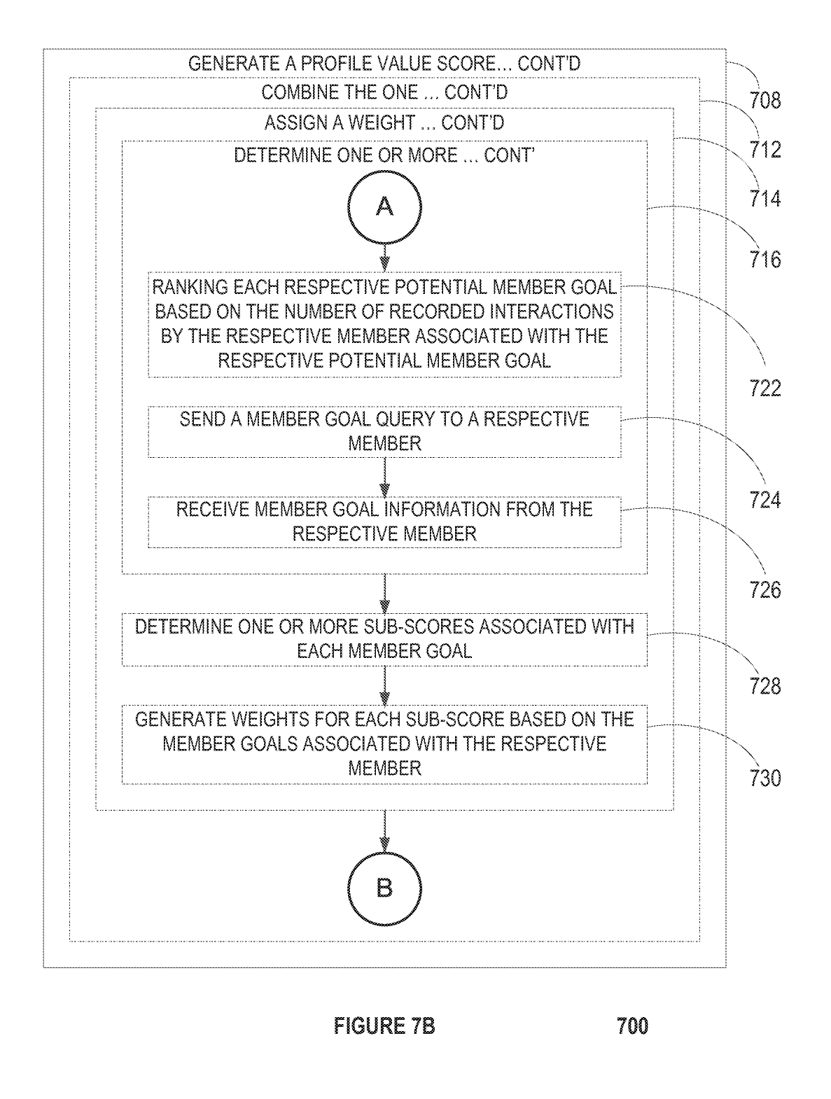

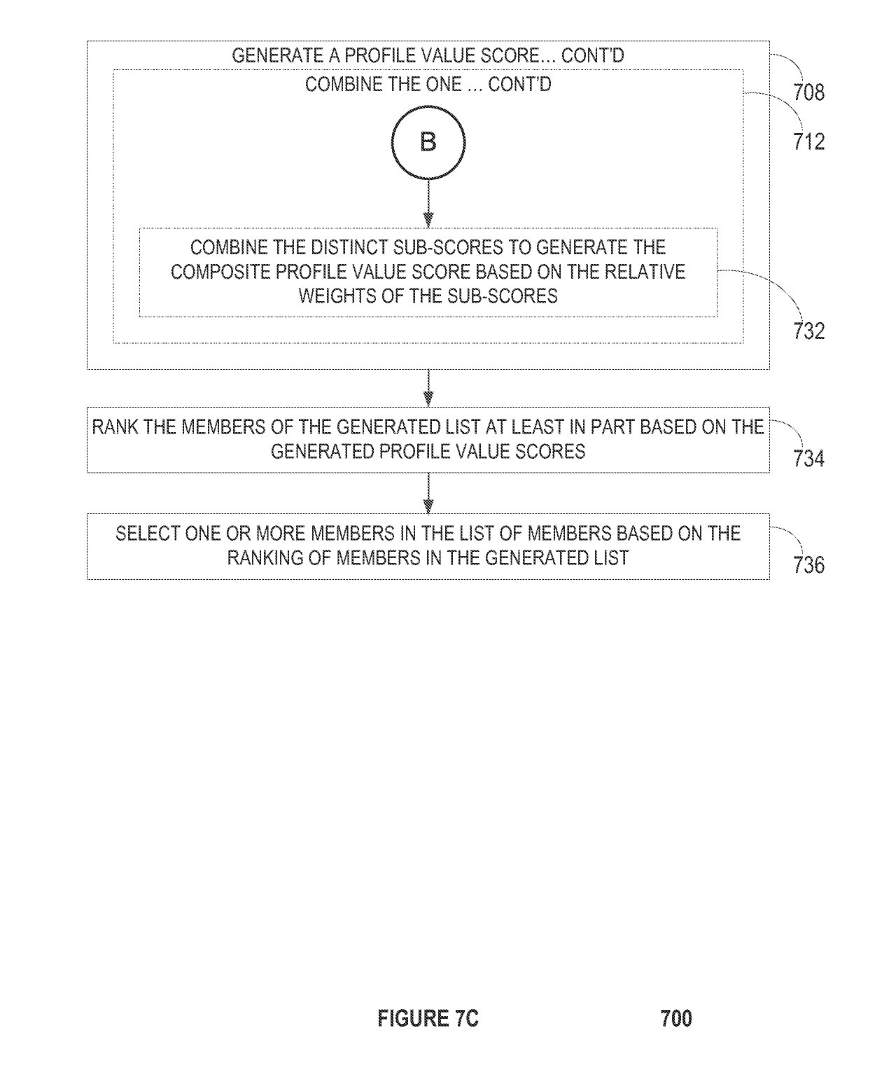

FIG. 7A is a flow diagram illustrating a method, in accordance with some example embodiments, for generating a composite profile value score. Each of the operations shown in FIG. 7A may correspond to instructions stored in a memory 306 or a computer-readable storage medium. Optional operations are indicated by dashed lines (e.g., boxes with dashed-line borders). In some embodiments, the method 700 described in FIG. 7A is performed by the social networking system (e.g., system 120 in FIG. 1). However, the method 700 can also be performed by any other suitable configuration of electronic hardware.

In some embodiments, the method 700 is performed at a social networking system (e.g., system 120 in FIG. 1) including one or more processors and memory 306 storing one or more programs for execution by the one or more processors.

In some example embodiments, the social networking system (e.g., system 120 in FIG. 1) receives (702) a member opportunity request. An opportunity is determined when the social networking system (e.g., system 120 in FIG. 1) (or some component of the social networking system) determines that content is needed for a web page requested by a member. For example, a first member requests the home page of the social networking system (e.g., system 120 in FIG. 1) associated with the first member.

In some example embodiments, the requested home page is designed to include a section that displays one or more recommended member contacts for the first member. Thus, when the social networking system (e.g., system 120 in FIG. 1) generates the requested webpage, it needs to determine one or more members to be recommended in that section. Each potential recommendation spot is then an opportunity for another member to be recommended. In other example embodiments, opportunities are identified to share content created by a member with other members (e.g., in an interaction feed).

In some example embodiments, the opportunity request includes information identifying a first member associated with the opportunity request. Thus, when an opportunity request is received, it includes metadata about the request including the identity of the member for whom the page is being created (or to whom the selected member or content will be displayed).

In some example embodiments, the social networking system (e.g., system 120 in FIG. 1) generates (704) a list of members in response to the received member opportunity request, wherein the list of members is determined based on member profile data stored at a social networking system. For example, the social networking system (e.g., system 120 in FIG. 1) determines the member to whom the selected members or content items will ultimately be displayed (e.g., on a page prepared for the member).

In some example embodiments, to generate the list of members in response to the received member opportunity request, the social networking system (e.g., system 120 in FIG. 1) uses (706) member profile data for the first member to identify appropriate members to be included in the list of members. For example, members may be included on the list based on the number of common contacts with the first member or past biographic details in common (e.g., common university or common employer) with the first member.

For each member in the generated list of members, the social networking system (e.g., system 120 in FIG. 1) generates (708) a profile value score based on the stored member profile data. In some example embodiments, the profile value score for a member profile associated with a member is a representation of the amount that the member has been suggested, displayed, or recommended through the social networking system (e.g., system 120 in FIG. 1). In some example embodiments, the social networking system (e.g., system 120 in FIG. 1) determines members that have the most exposure on the social networking system (e.g., system 120 in FIG. 1) or the members who have had the least exposure on the social networking system 120.

In some example embodiments, generating a profile value score includes multiple steps. In some example embodiments, the social networking system (e.g., system 120 in FIG. 1) generates (710) one or more distinct sub-scores. Each distinct sub-score represents a different aspect of the profile value score. Examples of sub-scores include, but are not limited to, a subject matter expert sub-score, job opportunity sub-score, network maintenance score, and network growth sub-score.

A subject matter expert sub-score measures the degree to which a member is considered an expert on a specific subject (or in general). A metric for measuring a member's standing as an expert is by the number of unique non-connections engaging with the online identity of the members. For example, the social networking system (e.g., system 120 in FIG. 1) determines the number of in-mails a member receives and the number of non-anonymous, non-self profile views the members receives during a specific time period. To determine expertise in specific subjects, the social networking system (e.g., system 120 in FIG. 1) analyzes the messages and the visiting members to determine the subject of the messages and the interests of the members.

A job opportunity sub-score measures the degree to which a member has opportunities to seek a job. In some example embodiments, the metric used to measure the job opportunity sub-score is the number of recruiter (job poster) messages received and the number of times a recruiter (or job poster) visits the profile of the member. In some example embodiments, the social networking system (e.g., system 120 in FIG. 1) only considers recruiters or job posters who operate in the field in which the member works or would seek employment (e.g., based on former employers or education history).

A network maintenance score measure the degree that a member continues to engage with their current social network. In some example embodiments, the network maintenance sub-score is measured by tracking the number of messages sent from the member to social contacts, the number of messages received from social contacts of the member, and the number of profile views to and from social contacts.

A growth maintenance sub-score measures the degree that a member is able to grow their current social network. In some example embodiments, the network growth sub-score is measured by tracking the number of connection invites sent, received, and accepted.

In some example embodiments, the social networking system (e.g., system 120 in FIG. 1) combines (712) the one or more distinct sub-scores to generate the composite profile value score. In this way, the profile value score represents a combination of several different sub-scores.

In some example embodiments, the social networking system (e.g., system 120 in FIG. 1) assigns (714) a weight to each distinct sub-score based on stored member profile data. In some example embodiments, the weight assigned to each sub-score determines the degree to which each sub-score influences the final profile value score.

In some example embodiments, the social networking system (e.g., system 120 in FIG. 1) determines (716) one or more member goals associated with members of the social networking system. Member goals describe the current interests of the members (e.g., what result the member is seeking to achieve through their participation in the social networking system). For example, some members are looking to meet new people, find a job, or expand their circle of influence in their field. By determining one or more member goals, the social networking system (e.g., system 120 in FIG. 1) determines which aspects of the social networking system services are most important to the member.

In some example embodiments, determining one or more member goals associated with members of the social networking system comprises, for a respective member, includes the social networking system (e.g., system 120 in FIG. 1) accessing (718) one or more recorded interactions by the respective member's interactions. For example, each time a member interacts with the social networking system (e.g., system 120 in FIG. 1) to view a profile, send a message, leave a comment, and so on, the system (with the member's permission) records the interaction in a database. These recorded interactions can then be accessed it the future to improve the system's services for the member.

Once a stored interaction has been accessed, the social networking system (e.g., system 120 in FIG. 1) determines (720), for the recorded activity, whether the recorded interaction indicates member interest in a specific member goal. For example, an interaction representing the member visiting a posted job opening would be associated with the job seeking goal. Similarly, a member commenting on an article about computer security may be associated with the developing expertise goal. Each recorded interaction (e.g., within a given period of time) is the associated with one or more goals. In some example embodiments, interactions are weighted based on how recent the interaction was recorded (e.g., interactions recorded this week are more important the interactions more than three weeks ago).

FIG. 7B is a flow diagram illustrating a method, in accordance with some example embodiments, for generating a composite profile value score. Each of the operations shown in FIG. 7B may correspond to instructions stored in a computer memory or computer-readable storage medium. Optional operations are indicated by dashed lines (e.g., boxes with dashed-line borders). In some embodiments, the method described in FIG. 7B is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) ranks (722) each respective potential member goal based on the number of recorded interactions by the respective member associated with the respective potential member goal. Thus, each goal has a number or point value assigned to it based on the number of interactions that were associated with the goal. The social networking system (e.g., system 120 in FIG. 1) then determines one or more goals as the most important goals to a particular member.

In some example embodiments, the social networking system (e.g., system 120 in FIG. 1) sends (724) a member goal query to a respective member. For example, when a member joins the social networking system the system, the system requests member goal information from the member. In some example embodiments, the social networking system (e.g., system 120 in FIG. 1) will periodically request updated member goal information.

In some example embodiments, the social networking system (e.g., system 120 in FIG. 1) receives (726) member goal information from the respective member. For example, the member fills out the received query and transmits it back to the social networking system (e.g., system 120 in FIG. 1).

The social networking system (e.g., system 120 in FIG. 1) then determines (728) one or more sub-scores associated with each member goal. For example, the job-seeker member goal is associated with the job opportunity sub-score.

The social networking system (e.g., system 120 in FIG. 1) then generates (730), for each respective member, weights for each sub-score based on the member goals associated with the respective member. Thus, sub-scores that are associated with identified goals of the member are weighted more heavily than sub-scores that are not associated with the identified goals of the member. In some example embodiments, weights generated for each sub-score are determined, at least in part, in accordance with the ranking of member goals associated with the each sub-score.

FIG. 7C is a flow diagram illustrating a method, in accordance with some example embodiments, for generating a composite profile value score. Each of the operations shown in FIG. 7C may correspond to instructions stored in a computer memory or computer-readable storage medium. Optional operations are indicated by dashed lines (e.g., boxes with dashed-line borders). In some embodiments, the method described in FIG. 7C is performed by the social networking system (e.g., system 120 in FIG. 1). However, the method described can also be performed by any other suitable configuration of electronic hardware.

In some embodiments the method is performed at a social networking system (e.g., system 120 in FIG. 1) including one or more processors and memory storing one or more programs for execution by the one or more processors.

In some example embodiments, the social networking system (e.g., system 120 in FIG. 1) combines (732) the distinct sub-scores to generate the composite profile value score based on the relative weights of the sub-scores.

The social networking system (e.g., system 120 in FIG. 1) then ranks (734) the members of the generated list at least in part based on the generated profile value scores. In some example embodiments, members with lower profile value scores are ranked higher than members with high profile value scores so that members with fewer recent opportunities are more likely to be selected to answer the opportunity request than members who have had many opportunities.

In some example embodiments, the social networking system (e.g., system 120 in FIG. 1) selects (736) one or more members in the list of members based on the ranking of members in the generated list. In some example embodiments, a specific number of members or content items are requested and that specific number of members are selected to fill the opportunity request. In other example embodiments, the social networking system (e.g., system 120 in FIG. 1) selects any members or content items that exceed a predetermined threshold.

### Software Architecture

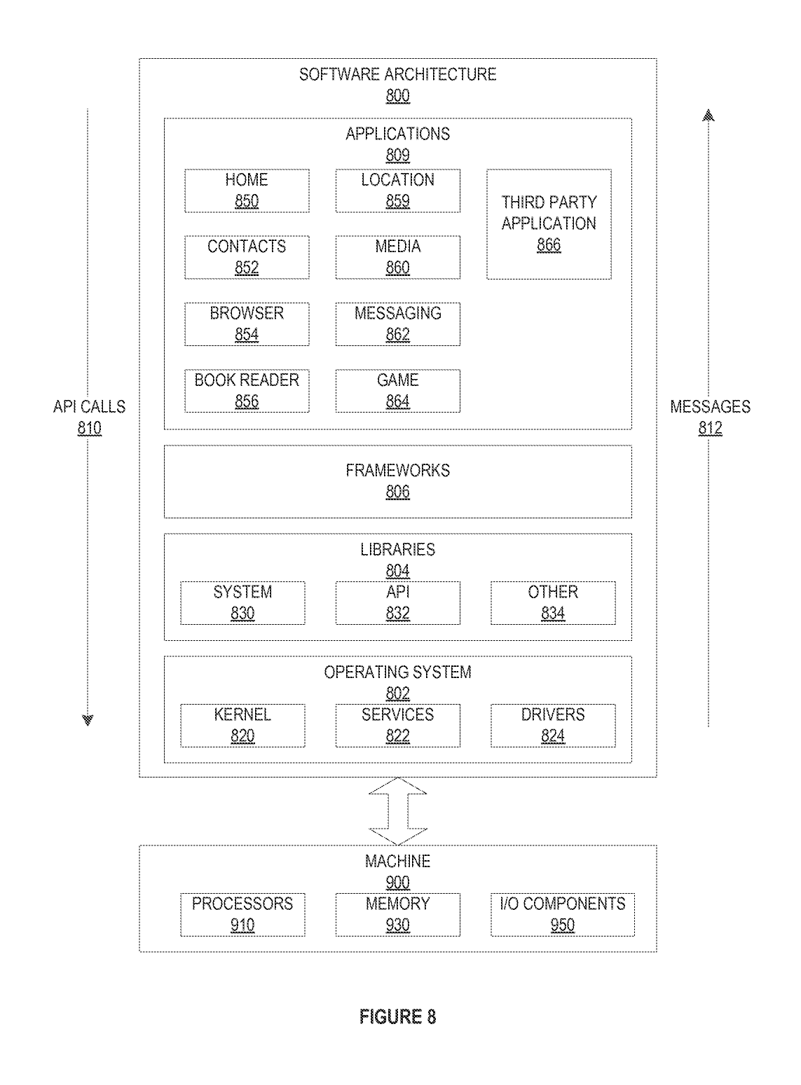

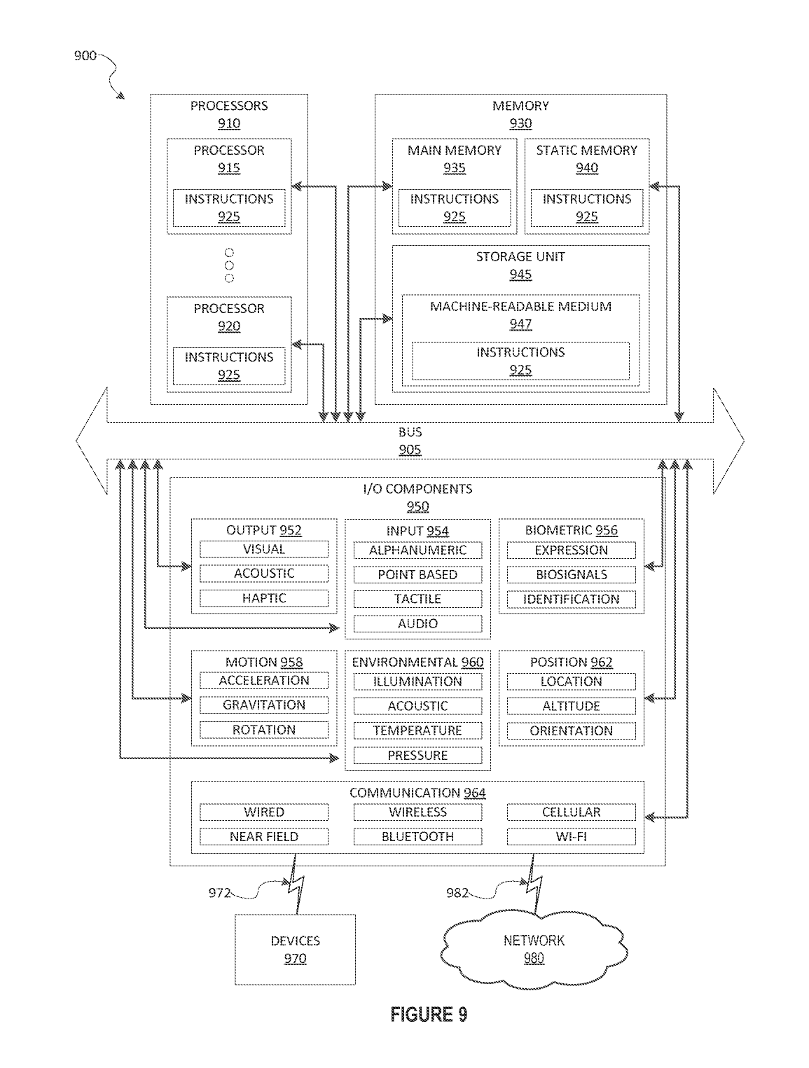

FIG. 8 is a block diagram illustrating an architecture of software 800, which may be installed on any one or more of the devices of FIG. 1. FIG. 8 is merely a non-limiting example of an architecture of software 800 and it will be appreciated that many other architectures may be implemented to facilitate the functionality described herein. The software 800 may be executing on hardware such as a machine 900 of FIG. 9 that includes processors 910, memory 930, and input/output (I/O) components 950. In the example architecture of FIG. 8, the software 800 may be conceptualized as a stack of layers where each layer may provide particular functionality. For example, the software 800 may include layers such as an operating system 802, libraries 804, frameworks 806, and applications 809. Operationally, the applications 809 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., a WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as a third party application 866. In a specific example, the third party application 866 (e.g., an application developed using the Android™ or iOS™ software development kit (SDK) by an entity other than the vendor of the particular platform) may be mobile software running on a mobile operating system 802 such as iOS™, Android™, Windows® Phone, or other mobile operating systems 802. In this example, the third party application 866 may invoke the API calls 810 provided by the mobile operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 915 and a processor 920, which may execute the instructions 925. The term “processor” is intended to include multi-core processors 910 that may comprise two or more independent processors 915, 920 (also referred to as “cores”) that may execute the instructions 925 contemporaneously. Although FIG. 9 shows multiple processors 910, the machine 900 may include a single processor 910 with a single core, a single processor 910 with multiple cores (e.g., a multi-core processor), multiple processors 910 with a single core, multiple processors 910 with multiple cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, the static memory 940, and the processors 910 may be considered machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store the instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be other machines 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 964 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS). High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HTTP). Similarly, the instructions 925 may be transmitted and/or received using a transmission medium via the coupling 972 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### TERM USAGE

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A method comprising:
receiving a member opportunity request,
generating a list of members in response to the received member opportunity request, wherein the list of members is determined based on member profile data stored at a social networking system;
for each member in the generated list of members, generating a profile value score based on the stored member profile data, wherein a profile value score for a member represents the amount of opportunity that the member has had;
ranking the members of the generated list at least in part based on the generated profile value scores;
selecting one or more members in the list of members based on the ranking of members in the generated list.

2. The method of claim 1, wherein generating a profile value score includes generating one or more distinct sub-scores.

3. The method of claim 2, further comprising, combining the one or more distinct sub-scores to generate the profile value score.

4. The method of claim 3, further comprising assigning a weight to each distinct sub-score based on stored member profile data; and
combining the distinct sub-scores to generate the composite profile value score based on the relative weights of the sub-scores.

5. The method of claim 4, further comprising:
determining one or more member goals associated with members of the social networking system;
determining one or more sub-scores associated with each member goal; and
for each respective member of the social networking system, generating weights for each sub-score based on the member goals associated with the respective member.

6. The method of claim 2, wherein the sub-scores include at least one of a subject matter expert sub-score, job opportunity sub-score, network maintenance sub-score, and network growth sub-score.

7. The method of claim 5, wherein determining one or more member goals associated with members of the social networking system comprises:
for a respective member of the social networking system;
accessing one or more recorded interactions by the respective member;
for each recorded interaction, determining whether the recorded interaction indicates member interest in a specific member goal; and
ranking each respective potential member goal based on the number of recorded interactions associated with the respective potential member goal performed by the respective member.

8. The method of claim 7, wherein weights generated for each sub-score are determined, at least in part, in accordance with the ranking of member goals associated with the each sub-score.

9. The method of claim 5, wherein determining one or more member goals associated with members of the social networking system comprises:
sending a member goal query to a respective member; and
receiving member goal information from the respective member.

10. The method of claim 1, wherein the opportunity request includes information identifying a first member associated with the opportunity request.

11. The method of claim 10, wherein generating a list of members in response to the received member opportunity request further comprises using member profile data for the first member to identify appropriate members to be included in the list of members.

12. A system comprising:
one or more processors;
memory; and
one or more programs stored in the memory, the one or more programs comprising instructions for:
receiving a member opportunity request,
generating a list of members in response to the received member opportunity request, wherein the list of members is determined based on member profile data stored at a social networking system;
for each member in the generated list of members, generating a profile value score based on the stored member profile data;
ranking the members of the generated list at least in part based on the generated profile value scores;
selecting one or more members in the list of members based on the ranking of members in the generated list.

13. The system of claim 12, wherein instructions for generating a profile value score further comprise instructions for generating one or more distinct sub-scores.

14. The system of claim 13, further comprising instructions for combining the one or more distinct sub-scores to generate the profile value score.

15. The system of claim 14 further comprising instructions for assigning a weight to each distinct sub-score based on stored member profile data; and
combining the distinct sub-scores to generate the composite profile value score based on the relative weights of the sub-scores.

16. A non-transitory computer readable storage medium storing one or more programs for execution by one or more processors, the one or more programs comprising instructions for:
receiving a member opportunity request,
generating a list of members in response to the received member opportunity request, wherein the list of members is determined based on member profile data stored at a social networking system;
for each member in the generated list of members, generating a profile value score based on the stored member profile data;
ranking the members of the generated list at least in part based on the generated profile value scores;
selecting one or more members in the list of members based on the ranking of members in the generated list.

17. The non-transitory computer readable storage medium of claim 16, wherein instructions for generating a profile value score further comprise instructions for generating one or more distinct sub-scores.

18. The non-transitory computer readable storage medium of claim 17, further comprising instructions for combining the one or more distinct sub-scores to generate the profile value score.

19. The non-transitory computer readable storage medium of claim 18, further comprising instructions for assigning a weight to each distinct sub-score based on stored member profile data; and
combining the distinct sub-scores to generate the composite profile value score based on the relative weights of the sub-scores.
